(19) United States
(12) Patent Application Publication
(10) Pub. No.: US 2014/0353337 A1
(43) Pub. Date: Dec. 4, 2014

(54) CONTAINER COVER AND DRIPPING CONTAINER

(71) Applicant: GC CORPORATION, Tokyo (JP)

(72) Inventors: Takumi SUZUKI, Tokyo (JP); Shinichi KOJIMA, Tokyo (JP)

(73) Assignee: GC CORPORATION, Tokyo (JP)

(21) Appl. No.: 14/286,245

(22) Filed: May 23, 2014

(30) Foreign Application Priority Data
May 29, 2013 (JP) 2013-113153

(51) Int. Cl. A61J 1/16

(52) U.S. Cl. CPC A61J 1/16
USPC 222/183

(57) ABSTRACT

Provided is a dripping container capable of inhibiting variation in dripping. The dripping container (1) capable of containing and dripping a liquid medicine, the dripping container includes a container (10) provided with a main body (11) to contain the liquid medicine formed in a tubular shape including a bottom on one side thereof and an opening portion (13a) with which the dripping container capable of dripping the liquid medicine, and a container cover (20) to cover the main body of the container, wherein the container cover includes an outer peripheral wall portion (21) to cover an outer peripheral portion of the container formed in a tubular shape and a bottom portion (22) to cover a bottom of the container, and a surface of the outer peripheral wall portion facing to the container is a surface having a close contact with the container.

### TECHNICAL FIELD

The present invention relates to a dripping container to drip a liquid medicine and a container cover to attach to the container.

### BACKGROUND ART

In dripping containers to take out a liquid medicine by dripping, especially in a dripping container used for a liquid medicine whose amount to be used per time is small (for instance, about one drop), it is important to avoid dripping a different amount of the liquid medicine from an intended amount by an operator. However, in a case where the liquid medicine includes a solvent having a low boiling point, there is a drawback that, in reality, drops larger in number of the liquid medicine are dripped than intended. It is considered that such a drawback is caused by temperature change due to heat transfer (conduction, radiation) of body temperature from operator's hands and fingers to change a viscosity of the liquid medicine or to volatilize the liquid medicine, thereby increasing inner pressure of inside of the container. Also, such a drawback is seen remarkably when using the liquid medicine stored in a fridge. Therefore it is considered that change in atmosphere temperature when the liquid medicine is taken out from the fridge is a factor of the drawback.

Accordingly, prior arts such as Patent Documents 1to 3 are disclosed for the purpose of preventing such a drawback.

Patent Document 1 (Japanese Patent No. 3572158) discloses a dropping tool for liquid with which a heat insulation cover is attached in a manner to cover side and bottom of a container main body, and an inner surface of the heat insulation cover includes a plurality of ribs to make a hollow space between the container main body and the heat insulation cover. It is said that the hollow space increases heat insulation property, whereby the drawback described above can be prevented.

Patent Document 2 (Japanese Patent Application Laid-Open No. 2000-85860) discloses a bottle container including a bottle and a plastic container capable of containing and removing the bottle, wherein the container includes a movable piece on the side wall portion. It is said that, according to the bottle container, organizing and storage of the bottle is easy, and it is possible to prevent contamination of fingers of operator and work table by the contents of the bottle.

Patent Document 3 (Japanese Patent Application Laid-Open No. 2009-207593) discloses a dripping container including a jacket that covers at least a side face of a container body at a predetermined interval. It is described that in order to prevent an excess amount of the liquid medicine from being pushed out from the container body, because of transmission of body temperature from hands to grab the container when the liquid medicine is dripped whereby volume expansion of the contents in the container body occurs even though in a small amount; it is preferable to provide a jacket.

### SUMMARY OF THE INVENTION

### Problems to be Solved by the Invention

It is described that the dropping tool for liquid in Patent Document 1 includes an air layer between the container body and the heat insulation cover, and Patent Documents 2 and 3 describe that it is very effective to have a hollow space between the bottle and the container. However, if such an air layer or a hollow space is provided, since cold air in the air layer or the hollow space switches places with air having a room temperature when the bottle is taken out from the fridge, the bottle is subjected to the air having a room temperature to lower cooling capacity, whereby the above described problems can be caused.

Accordingly, an object of the present invention is to provide a dripping container capable of inhibiting variation in dripping and to provide a container cover used for the dripping container.

### Means for Solving the Problems

Hereinafter, the present invention will be described. In order to make the present invention easy to understand, reference numerals given in the accompanying drawings are shown here in parentheses. However, the present invention is not limited to this.

A first aspect of the present invention resolves the above problem by a dripping container (1) capable of containing and dripping a liquid medicine, the dripping container comprising a container (10) provided with a main body (11) having a tubular shape including a bottom on one side thereof to contain the liquid medicine and an opening portion (13a) that makes it possible to drip the liquid medicine, and a container cover (20) to cover the main body of the container, wherein the container cover includes an outer peripheral wall portion (21) to cover an outer peripheral portion of the container having a tubular shape and a bottom portion (22) to cover the bottom of the container, and a surface of the outer peripheral wall portion facing to the container is a surface having a close contact with the container.

Here, the “surface having a close contact” refers that the surface of the outer peripheral wall portion has a shape fitting to the outer periphery of the container, whereby the surface of the outer peripheral wall portion and the outer periphery of the container have a close contact with each other and any intentional air layer is not formed.

A second aspect of the present invention is the dripping container (1) according to the first aspect, wherein a surface of the bottom portion (22) of the container cover (20), the surface on a side facing to the container (10) is a surface having a close contact with the container.

The “surface having a close contact” has a same meaning as above.

A third aspect of the present invention is the dripping container (1) according to the first aspect, wherein the container cover (20) is made of a thermoplastic elastomer.

A fourth aspect of the present invention is the dripping container (1) according to the first aspect, wherein a wall thickness of the container cover (20) is 2.0 mm or more.

A fifth aspect of the present invention is the dripping container (101) according to the first aspect, wherein a slit (20b) is arranged on the outer peripheral wall portion (21) of the container cover (20) along an axis direction of the tubular shape of the container (10).

A sixth aspect of the present invention is the dripping container (201) according to the first aspect, wherein a groove (20c) is formed on the bottom portion (22) of the container cover (20) on a surface opposite to the surface facing to the container (10).

A seventh aspect of the present invention is the dripping container (301) according to the first aspect, wherein a ringed band (20d) is provided to the outer peripheral wall portion (21) of the container cover (20).

An eighth aspect of the present invention is a container cover (20) to cover at least a part of a container (10) capable of containing and dripping a liquid medicine, the container cover comprising an outer peripheral wall portion (21) having a tubular shape, and a bottom portion (22) disposed in a manner to cover up one end of the tubular shape of the outer peripheral wall portion, wherein an inner peripheral surface of the tubular shape of the outer peripheral wall portion is a smooth surface.

A ninth aspect of the present invention is the container cover (20) according to the eighth aspect, wherein an inner surface of the bottom portion (22) is a smooth surface.

A tenth aspect of the present invention is the container cover (20) according to the eighth aspect, wherein the outer peripheral wall portion (21) is made of a thermoplastic elastomer.

An eleventh aspect of the present invention is the container cover (20) according to the eighth aspect, wherein a wall thickness of the outer peripheral wall portion (21) is 2.0 mm or more.

A twelfth aspect of the present invention is the container cover (20) according to the eighth aspect, wherein a slit (20b) is provided to the outer peripheral wall portion (21) along an axis direction of the tubular shape of the outer peripheral wall portion.

A thirteenth aspect of the present invention is the container cover (20) according to the eighth aspect, wherein a groove (20c) is provided on a surface of the bottom portion (22), which surface is to be on an external side.

A fourteenth aspect of the present invention is the container cover (20) according to the eighth aspect, wherein a ringed band (20d) is provided to the outer peripheral wall portion (21).

### Effects of the Invention

According to the present invention, it is possible to keep heat insulation property and heat-retention property (cool keeping property) high. Therefore, the contents is insulted from the influence of heat of hands and fingers, and it is possible to hold down temperature change of the liquid medicine contained in the container even when a rapid temperature change occurs outside, whereby it is possible to secure an appropriate and stable dripping amount.

### BRIEF DESCRIPTION OF THE DRAWINGS

FIG. 1A is a perspective view of a dripping container 1, and FIG. 1B is an exploded perspective view of the dripping container 1;

FIG. 2A is a cross-sectional view of the dripping container 1, and FIG. 2B is an exploded cross-sectional view of the dripping container 1;

FIG. 3 is a perspective view of a dripping container 101;

FIG. 4 is a perspective view of a dripping container 201;

FIG. 5 is a view illustrating attaching and removing of a container 10 of the dripping container 201;

FIG. 6A is a perspective view of a dripping container 301, and

FIG. 6B is a perspective view of the dripping container 301 in a different posture.

### MODES FOR CARRYING OUT THE INVENTION

The functions and benefits of the present invention will be apparent from the following modes for carrying out the invention. Hereinafter, the present invention will be described based on embodiments shown in the drawings. However, the present invention is not limited to these embodiments.

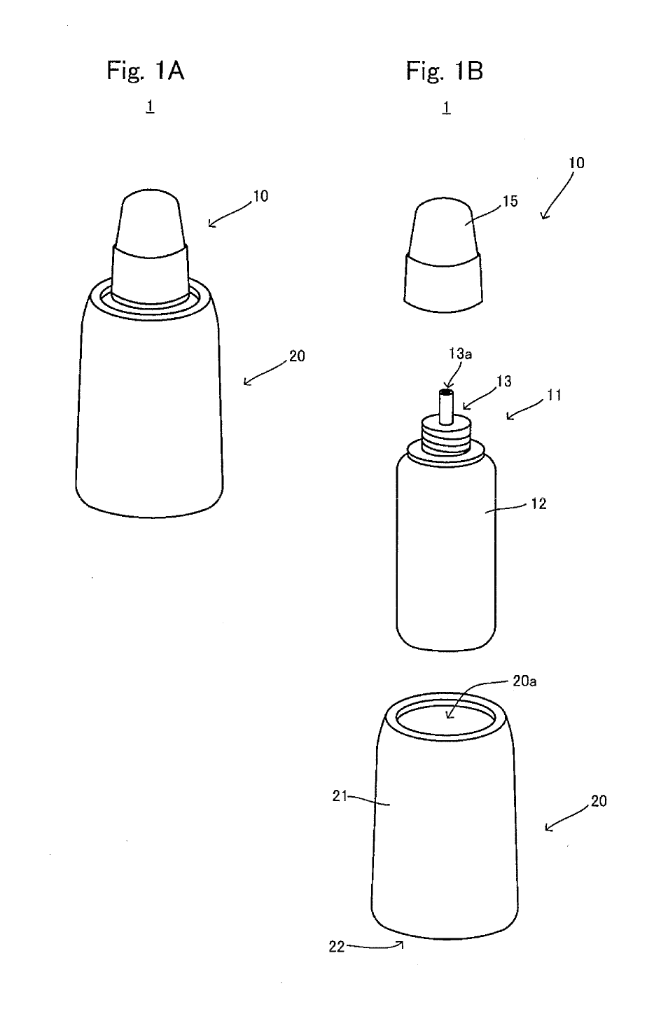

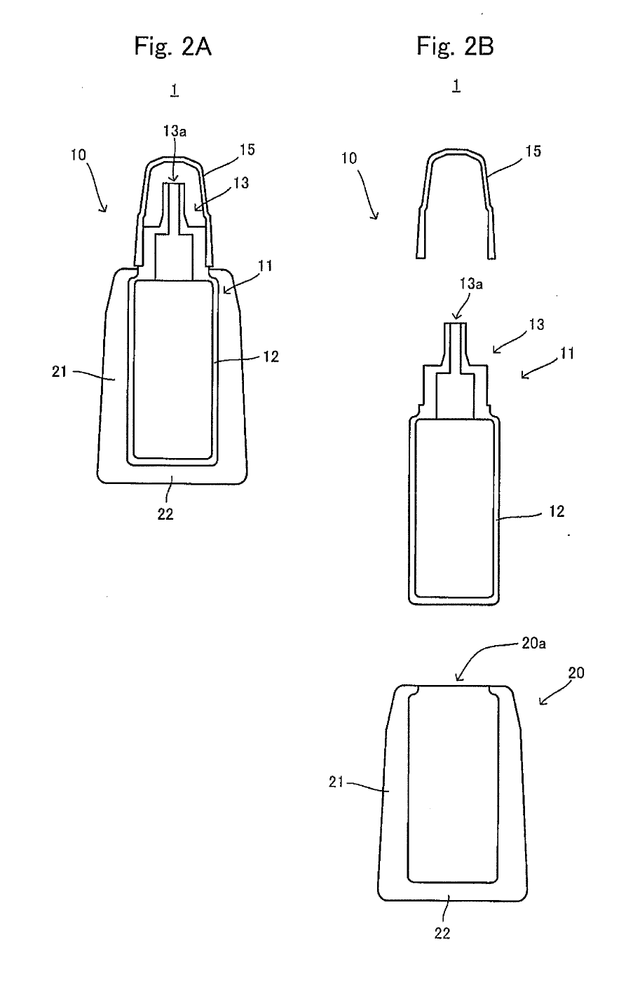

FIG. 1 is a view illustrating a first embodiment. FIG. 1A is a perspective view of a dripping container 1, and FIG. 1B is an exploded perspective view of the dripping container 1. FIG. 2A is a cross-sectional view of the dripping container 1, and FIG. 2B is an exploded cross-sectional view of the dripping container 1.

The dripping container 1 includes a container 10 for containing a liquid medicine and a container cover 20 to cover at least a part of the container 10.

The container 10 includes a main body 11 in which a liquid medicine is to be contained and a cap 15 attached to and removed from the main body 11.

As the main body 11, a similar main body to a known dripping container can be applied, however, in this embodiment, the main body 11 includes a liquid medicine containing part 12 being a container formed in a tubular shape including a bottom on one end, and a liquid medicine dripping part 13 having a structure with which the liquid medicine can be taken out by dripping. The liquid medicine containing part 12 is a part to contain and store a liquid medicine, being a container formed in a tubular shape having a predetermined capacity and including a bottom on one end. On the other hand, the liquid medicine dripping part 13 is communicated with the liquid medicine containing part 12, disposed to an opening of the medicine containing part 12 on a side where a bottom is not formed. The liquid medicine dripping part 13 is a part configured such that the liquid medicine is dripped outside of the container 10 to be taken out and including an opening portion 13a to drip and take out the liquid medicine. On an outer peripheral portion of the liquid medicine dripping part 13, an external thread is provided to screw together with an internal thread formed on an inner surface of the cap 15.

At least the liquid medicine containing part 12 of the main body 11 has a flexibility, and configured such that, even when being deformed by pressing and the like, the shape thereof can be restored to an original state by unloading the pressure. Also, the liquid medicine containing part 12 has preferably transparency so that remaining amount and state of the contained liquid medicine can be visually confirmed. However, in a case where the liquid medicine containing part 12 needs to block light considering a property of the liquid medicine to be contained (for example, in a case where the liquid medicine has a property of right curing), the liquid medicine containing part 12 does not necessarily have transparency.

Considering this viewpoint, as a material to configure the liquid medicine containing part 12, a plastic such as polypropylene, polyethylene or the like can be employed for example.

The cap 15 is a removable cap that can be attached in a manner to cover the liquid medicine dripping part 13 of the main body 11. As described above, an internal thread is formed on an inner surface of the cap 15 to screw together with the external thread provided to the outer periphery of the liquid medicine dripping part 13.

The container cover 20 is a member formed in a container shape, and formed including an outer peripheral wall portion 21 and a bottom portion 22 to cover up one end of the tubular shape of the outer peripheral wall portion 21. That is, the container cover 20 is formed in a tubular shape including the bottom portion 22 on the one end, and an opening portion 20a is formed on the other end. Through the opening portion 20a, the container 10 can be inserted and removed. Also, the container 10 is removed when the liquid medicine in the container 10 is run out and a new container 10 is inserted into the container cover 20. Therefore, the container cover 20 is formed of a material having durability to resist repeating use.

In the container cover 20, an inner peripheral surface of the outer peripheral wall portion 21 (a surface on a side facing to the outer peripheral surface of the container 10) is made to be a smooth surface fitting to the outer peripheral surface of the liquid medicine containing part 12. By making the smooth surface fitting to the outer peripheral surface of the liquid medicine containing part 12, when the inner peripheral surface is disposed having contact with the outer peripheral surface of the container 10 as described below, the inner peripheral surface of the outer peripheral wall portion 21 and the outer peripheral surface of the liquid medicine containing part 12 of the main body 11 of the container 10 have a close contact with each other, which prevents an intentional air layer from being formed. Therefore, it is preferable that inside of the outer peripheral wall portion 21 which forms the wall thickness of the outer peripheral wall portion 21 does not have any hollow portion, and the inside of the portion that forms the wall thickness of the outer peripheral wall portion 21 is preferably solid. That is, here, “fitting to the outer peripheral surface of the liquid medicine containing part”, “smooth surface” and “the outer peripheral surface of the liquid medicine containing part has a close contact” each means a configuration in which any intentional air layer as described above is not formed.

It is also preferable that the inner surface of the bottom portion 22 of the container cover 20 (a surface on a side facing to the bottom of the container 10) is also made to be a smooth surface fitting to the outer peripheral surface of the bottom portion of the liquid medicine containing part 12, and is having a close contact with the outer peripheral surface of the bottom portion of the liquid medicine containing part 12.

At least the outer peripheral wall portion 21 of the container cover 20 is configured by a thick material having flexibility. The bottom portion 22 is preferably configured in the same manner. Thereby a container cover having a high cool keeping capacity can be made. That is, if an air layer is used for heat insulation, since air existing in the air layer (heat insulation layer) is very light in weight and has a small specific heat, its heat capacity is very small. On the other hand, by forming the container cover by a thick material, since it is possible to apply a material having a high specific heat with a thick layer, a container cover having a large heat capacity can be made. For this reason, cool keeping capacity is increased.

Also, a dripping container is easy to fall down especially when remaining amount of the liquid medicine inside becomes small thereby becoming light as a whole for example. However, by making the wall of the container cover 20 thick, the dripping container 1 has a certain amount of weight, whereby it is possible to prevent the dripping container from falling down.

More specifically, the wall thickness of the outer peripheral wall portion 21 is 2.0 mm to 10 mm, preferably 2.5 mm to 4.5 mm, more preferably 3.0 mm to 4.0 mm. This makes it possible to increase the cool keeping effect and to keep ease of pressing of the container to drip.

Also, specific heat that affects the heat capacity is preferably 1200 J/(kg·K) to 3000 J/(kg·K). This makes it possible to further increase the cool keeping effect.

Also, it is preferable that the material to configure the container cover 20 has a low thermal conductivity. By employing a material having a low thermal conductivity and large thickness as above, it is possible to obtain a high heat insulation capacity. More specifically, preferably the thermal conductivity is 0.1 W/(m·K) to 0.5 W/(m·K).

Considering above viewpoints, as a material favorable to configure at least the outer peripheral wall portion 21 of the container cover 20, a thermoplastic elastomer can be exemplified. It is preferable that the bottom portion 22 is also formed by a thermoplastic elastomer. As the thermoplastic elastomer, styrene thermoplastic elastomers, olefin thermoplastic elastomers, vinyl chloride thermoplastic elastomers, and urethane thermoplastic elastomers are preferable. Among these, in styrene thermoplastic elastomers, styrene-ethylene•propylene-styrene block copolymer is more preferable since it has flexibility (shore A hardness of 50 or less), and has a small haze value (20% or less with a thickness of 2 mm).

Also, since thermoplastic elastomers can be shaped in a large scale at low cost by means of mold injection, it has advantages in productivity and cost performance.

Further, at least the outer peripheral wall portion 21 of the container cover 20 has preferably transparency so that a label pasted on the container 10 and the liquid medicine contained in the container 10 can be seen. More specifically, at least the outer peripheral wall portion 21 of the container cover 20 has a haze value of 70% or less with a thickness of 2 mm, more preferably 30% or less with a thickness of 2 mm. Also, if a projection such as a lib is not provided to the outer peripheral portion of the outer peripheral wall portion 21 of the container cover 20, the container 10 becomes easier to be seen.

The container 10 and the container cover 20 as described above are combined as follows to be the dripping container 1. That is, as shown well in FIGS. 1A and 2A, the liquid medicine containing part 12 of the container 10 is contained inside the container cover 20, and the liquid medicine dripping part 13 is disposed to project from the opening portion 20a of the container cover 20. This makes it possible to drip the liquid medicine, which is a basic function as the dripping container 1, with the container cover 20 being attached to the container 10.

Since the container cover 20 is formed thick by a material having a low heat conductivity, it is possible to drip the liquid medicine stably without receiving influence from heat of hands and fingers.

Also, as can be seen from FIG. 2A, since the inner peripheral surface of the container cover 20 is made to be a smooth surface fitting to the outer peripheral surface of the liquid medicine containing part 12, the outer peripheral surface of the container 10 and the inner peripheral surface of the outer peripheral wall portion 21 of the container cover 20 have a close contact with each other, and no intentional hollow space is formed. Also, if a side of the inner surface of the bottom portion 22 of the container cover 20 is made to be a smooth surface fitting to the outer surface of the bottom portion of the liquid medicine containing part 12, the outer surface of the bottom surface of the container 10 and the inner surface of the bottom portion 22 of the container cover 20 also have a close contact with each other, whereby a hollow space is not intentionally formed.

For this reason, for instance, even when temperature is changed by taking out the dripping container 1 from the fridge and temperature on a side of the outer periphery of the dripping container 1 is changed rapidly because of the body temperature when the dripping container 1 is picked from the operator, since air layer is not provided between the container 10 and the container cover 20, switching of air due to convection does not occur, whereby high cool keeping capacity is maintained, therefore temperature of the liquid medicine can be kept longer than before. Further, since the container cover 20 is formed thick as described above, heat capacity is large to control temperature change to be moderate, which makes it possible to further increase the above effects.

As shown above, according to the container cover 20 and the dripping container 1 equipped with the container cover 20, it is possible to moderate temperature change of the liquid medicine contained in the dripping container 1 compared with before, against a rapid temperature change occurred at the outer peripheral portion. Therefore, it is possible to sustain the state of the liquid medicine inside the container stably, thereby obtaining an appropriate and stable amount when the operator drips the liquid medicine.

Here, the container cover 20 preferably covers as large portion of the liquid medicine containing part 12 of the container 10 as possible. This makes it possible to exert the above effects more remarkably. Especially, it is preferable that the liquid medicine containing part 12 is covered by the container cover 20 up to near the boundary with the liquid medicine dripping part 13.

Insertion of the container 10 to the container cover 20 can be carried out from the opening portion 20a. At this time, since the container cover 20 has flexibility as described above, the insertion can be carried out easily.

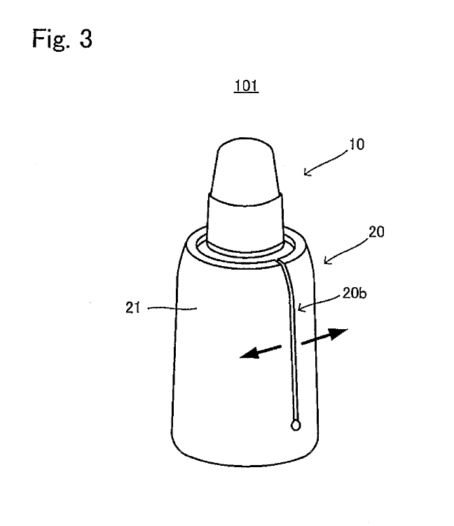

FIG. 3 is a view illustrating a second embodiment, a perspective view of a dripping container 101. The dripping container 101 includes a slit 20b provided to the outer peripheral wall portion 21 of the container cover 20 along an inserting direction of the container 10 (an axis direction of the tubular shape of the liquid medicine containing part 12, an axis direction of the tubular shape of the outer peripheral wall portion 21).

According to this, when the container 10 is inserted to or removed from the container cover 20, the container cover 20 can be open in right and left from the slit 20b in opposite direction to each other as shown by straight arrows in FIG. 3, which makes it easy to insert and remove the container 10.

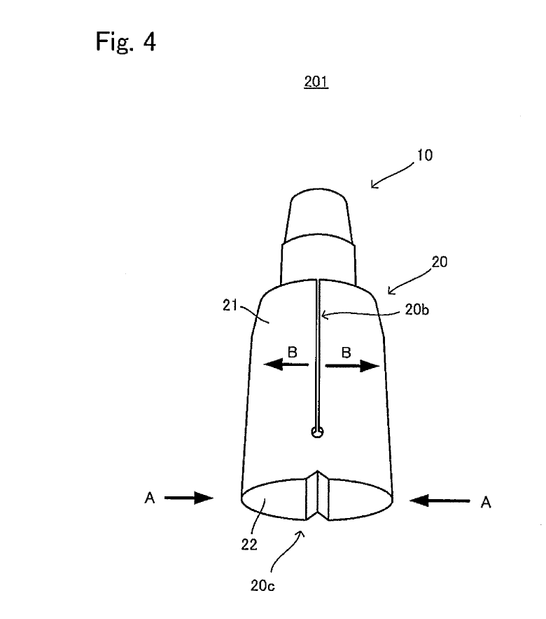

FIG. 4 is a view illustrating a third embodiment, a perspective view seen from an angle in which the slit 20b comes to front, and the bottom portion 22 can be seen. The dripping container 201 includes, in addition to the slit 20b described above, a groove 20c formed on outside of the bottom portion 22 of the container cover 20 (opposite side of the side of the container 10). In the groove 20c, the bottom portion 22 is made to be thin. A longitudinal direction of the groove 20c is preferably along to a direction in which a longitudinal direction of the slit 20b is extended along the bottom portion 22.

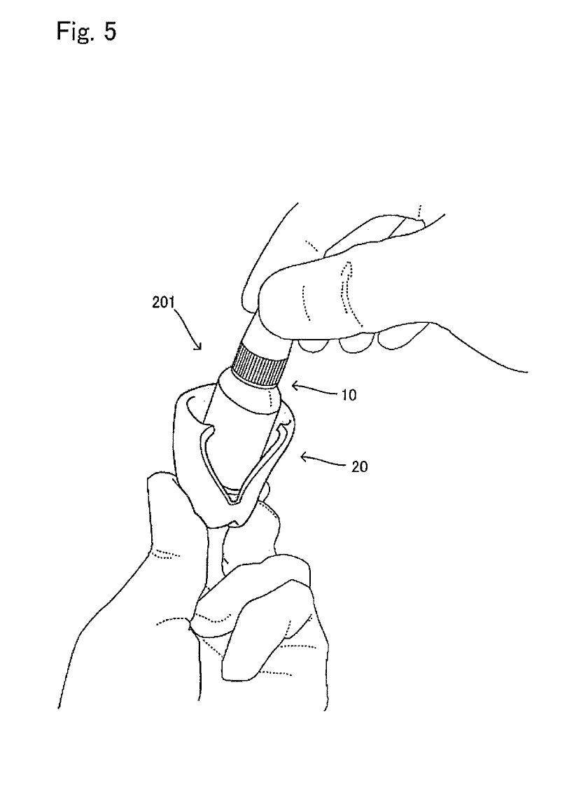

According to this, in the same way as above, inserting and removing of the container 10 to/from the container cover 20 becomes easier thanks to the slit 20b. Further, when the container 10 is attached to or removed from the container cover 20, as shown by arrows A in FIG. 4, if a lower portion of the container cover 20 is pressed, the bottom portion 22 bends from the groove 20c, whereby, as shown by arrows B in FIG. 4, the container cover 20 opens from the slit 20b. Because of this, the container 10 can be attached and removed like the image shown in FIG. 5, therefore it becomes much easier to attach and remove.

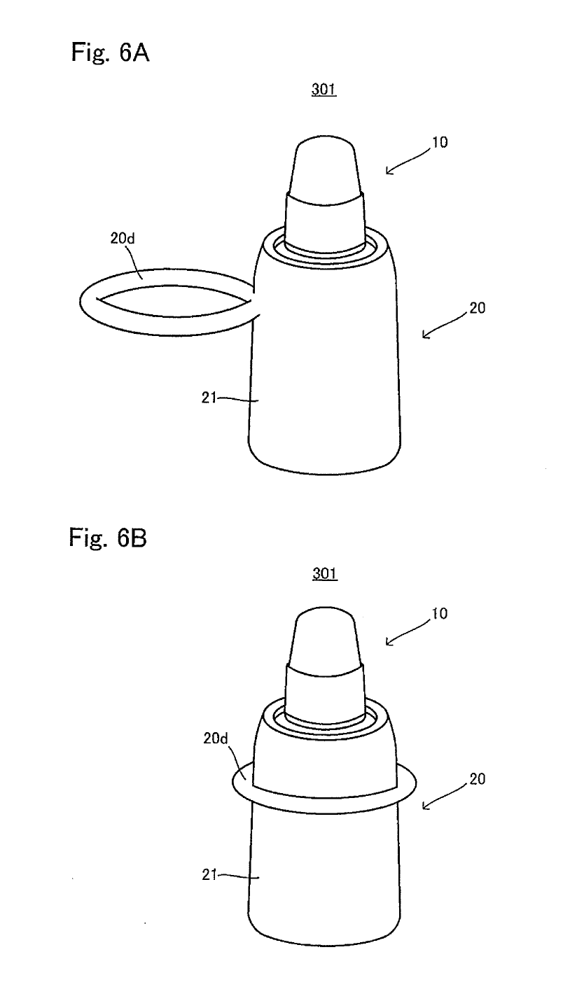

FIG. 6 is a view illustrating a fourth embodiment, a perspective view of the dripping container 301. FIG. 6A shows one posture and FIG. 6B shows another posture.

The dripping container 301, in addition to the dripping container 1, includes a ringed band 20d on outside of the outer peripheral wall portion 21 of the container cover 20. As the ringed band, a circular-ringed band, a square-ringed band and ringed bands in other forms can be exemplified. In this embodiment, the ringed band is a circular-ringed band. The band 20d, as with the container cover 20, is formed of a material having flexibility (retractility), and one part of the ringed shape is connected to the outer peripheral wall portion 21 as can be seen from FIG. 6A.

According to the dripping container 301 as described above, the container can have a posture in which nothing is disposed inside the ringed shape of the band 20d as shown in FIG. 6A, and a posture in which the outer peripheral wall portion 21 is disposed in a manner that the outer peripheral wall portion 21 is surrounded by the band 20d as shown in FIG. 6B.

In the posture shown in FIG. 6A, the container 10 can be inserted to and removed from the container cover 20. On the other hand, in the posture shown in FIG. 6B, the band 20d presses the outer peripheral wall portion 21 in a manner to thrust it to the container 10, whereby it is possible to increase adhesion between the container 10 and the container cover 20.

The band 20d can also be applied to the dripping container 101 and the dripping container 201 described above. In such a case, having a posture such that the outer peripheral wall portion 21 is surrounded by the band 20d, it is possible to prevent the slit 20d from opening.

### DESCRIPTION OF THE REFERENCE NUMERAL

1, 101, 201, 301 dripping container
10 container
11 main body
12 liquid medicine containing part
13 liquid medicine dripping part
15 cap
20 container cover
21 outer peripheral wall portion
22 bottom portion

1. A dripping container capable of containing and dripping a liquid medicine, the dripping container comprising:
a container provided with a main body having a tubular shape including a bottom on one side thereof to contain the liquid medicine and an opening portion with which the liquid medicine is capable to be dripped; and
a container cover to cover the main body of the container, wherein the container cover includes an outer peripheral wall portion to cover an outer periphery of the container, the outer periphery being formed in a tubular shape, and a bottom portion to cover the bottom of the container, and a surface of the outer peripheral wall portion facing to the container is a surface that has a close contact with the container.

2. The dripping container according to claim 1, wherein a surface of the bottom portion of the container cover, the surface being on a side facing to the container is a surface having a close contact with the container.

3. The dripping container according to claim 1, wherein the container cover is made of a thermoplastic elastomer.

4. The dripping container according to claim 1, wherein a wall thickness of the container cover is 2.0 mm or more.

5. The dripping container according to claim 1, wherein a slit is provided to the outer peripheral wall portion of the container cover along an axis direction of the tubular shape of the container.

6. The dripping container according to claim 1, wherein a groove is formed on the bottom of the container cover on a surface opposite to the surface facing to the container.

7. The dripping container according to claim 1, wherein a band is provided to the outer peripheral wall portion of the container cover.

8. A container cover to cover at least a part of a container capable of containing and dripping a liquid medicine, the container cover comprising:
an outer peripheral wall portion having a tubular shape; and
a bottom portion disposed in a manner to cover up one end side of the tubular shape of the outer peripheral wall portion, wherein an inner peripheral surface in a tubular shape of the outer peripheral wall portion is a smooth surface.

9. The container cover according to claim 8, wherein an inner surface of the bottom portion is a smooth surface.

10. The container cover according to claim 8, wherein the outer peripheral wall portion is made of a thermoplastic elastomer.

11. The container cover according to claim 8, wherein a wall thickness of the outer peripheral wall portion is 2.0 mm or more.

12. The container cover according to claim 8, wherein a slit is provided to the outer peripheral wall portion along an axis direction of the tubular shape of the outer peripheral wall portion.

13. The container cover according to claim 8, wherein a groove is provided on a surface of the bottom portion, the surface being to be on an external side.

14. The container cover according to claim 8, wherein a ringed band is provided to the outer peripheral wall portion.
